(19) United States
(12) Patent Application Publication
(10) Pub. No.: US 2026/0200666 A1
(43) Pub. Date: Jul. 16, 2026

(54) AERATION APPARATUS FOR MOUNTING WITHIN A HOPPER BOTTOM OF A GRAIN STORAGE BIN

(71) Applicants: Francisco Zacharias, Winkler (CA); Alberto Zacharias, Winkler (CA); Adolfo Zacharias, Winkler (CA)

(72) Inventors: Francisco Zacharias, Winkler (CA); Alberto Zacharias, Winkler (CA); Adolfo Zacharias, Winkler (CA)

(21) Appl. No.: 19/022,497

(22) Filed: Jan. 15, 2025

(51) Int. Cl. B65D 88/74; B65D 3/06; F26B 21/50

(52) U.S. Cl. CPC B65D 88/745; B65D 3/06; F26B 21/50

(57) ABSTRACT

An aeration apparatus mounts within a hopper bottom of a grain storage bin. The apparatus includes a duct member defining an upper boundary of an aeration duct of triangular cross-section that extends along an annular path about a central opening of the duct member. The duct member is supported spaced above the hopper bottom wall by leg members at the inner and outer perimeter edges of the duct member that are adjustable relative to one another. The central opening of the duct member is aligned with the central discharge gate of the hopper bottom so as not to interfere with grain flow down a central axis of the grain bin. The triangular upper boundary of the duct member is perforated to distribute aeration air upwardly into the grain above while also distributing air into grain below through an open bottom of the duct member.

### FIELD OF THE INVENTION

The present invention relates to an aeration apparatus defining an aeration duct for mounting inside a hopper bottom of a grain storage bin for distribution of aeration air into grain supported within the bin.

### BACKGROUND

Stored grain is known to require aeration to control moisture and prevent spoilage of the grain. United States Patents 11,414,265 by Siemens, 11,340,016 by O’Hare, 11,098,952 by Edlund, 10,994,924 by Rosumowitsch, and 8,720,079 by Neufeld and US Patent Application Publication No. 2024/0000023 disclose various examples of aeration ducts supported with a grain bin; however, known devices may not be well suited for both retrofit installation at an intermediate location into an existing bin while thoroughly penetrating aeration air into grain both above and below the aeration duct.

### SUMMARY OF THE INVENTION

According to one aspect of the invention there is provided an aeration apparatus for a grain storage bin having a bin boundary partly defined by a hopper bottom wall tapering downwardly and radially inwardly to a central discharge gate and an air supply duct communicating through the bin boundary for receiving aeration air from an external blower, the aeration apparatus comprising: a duct member defining an upper boundary of an aeration duct extending along an annular path about a central opening and being at least partially open at a lower boundary of the aeration duct; and a plurality of leg members arranged to support the duct member within the storage bin at a location spaced above the hopper bottom wall such that the central opening is generally aligned with the central discharge gate of the storage bin and such that the aeration duct communicates with the air supply duct to distribute the aeration air from the external blower within the storage bin.

The configuration of the duct member being at least partially open at a bottom side while being spaced above the hopper bottom wall by legs enables sufficient air penetration downwardly into grain below within the hopper bottom, together with central opening that aligns with hopper discharge so as not to a discharge flow of grain downwardly through a center of the bin when unloading. Preferably the duct member is perforated along the upper boundary of the duct.

According to the illustrated embodiment, the duct member defines a cross-sectional profile of the aeration duct that is triangular in shape. The duct member preferably comprises an inner wall sloping downwardly and radially inwardly from an apex of the upper boundary and an outer wall sloping downwardly and radially outwardly from the apex of the upper boundary such that the inner wall and the outer wall collectively define the triangular shape of the aeration duct. Preferably the apex has an interior angle which is less than 100 degrees. Preferably each of the inner wall and the outer wall is sloped downwardly and outwardly from the apex at an angle of at least 40 degrees from horizontal.

The duct member may be assembled from panel sections mounted onto a supporting frame, in which each panel section comprising a flat sheet.

Preferably each panel section is elongated in a circumferential direction of the annular path.

Each panel section may be joined to the supporting frame with fasteners.

The supporting frame may be formed of elongated frame members joined to one another and to the leg members with fasteners.

The duct member preferably has an outer perimeter that is polygonal in shape.

When the aeration duct defines a radial dimension (width) between an inner perimeter edge of the duct member that extends about the central opening and an outer perimeter edge of the duct member, preferably the radial dimension is greater than a height of the duct between the upper boundary and the lower boundary of the duct.

Preferably the radial dimension of the aeration duct is greater than a height of the outer perimeter edge from the hopper bottom wall.

The leg members may be arranged to support the duct member such that a height of the outer perimeter edge from the hopper bottom wall is greater than 6 inches, and less than 30 inches.

A diameter of the central opening of the duct member is preferably at least 2 feet.

Preferably an outer diameter of the duct member is greater than 5 feet.

The leg members may include inner leg members adjacent the central opening and outer leg members adjacent an outer perimeter of the duct member. Preferably at least some of the leg members are adjustable in configuration relative to one another such that the leg members are mountable onto the hopper bottom wall having slope angle in a range of 35 to 75 degrees from horizontal.

Preferably the duct member is arranged to communicate with the air supply duct through the at least partially open lower boundary.

### BRIEF DESCRIPTION OF THE DRAWINGS

One embodiment of the invention will now be described in conjunction with the accompanying drawings in which:

FIG. 1 is a perspective view of a top side of the aeration apparatus;

FIG. 2 is a perspective view of a bottom side of the aeration apparatus;

FIG. 3 is a perspective view of a frame assembly of the aeration apparatus with the panel sections removed for illustrative purposes;

FIG. 4 is a top plan view of the aeration apparatus;

FIG. 5 is a sectional view along the line 5-5 in FIG. 4, showing the aeration apparatus supported relative to a hopper bottom wall; and

FIG. 6 is a sectional view along the line 6-6 in FIG. 4, showing the aeration apparatus supported relative to the hopper bottom wall.

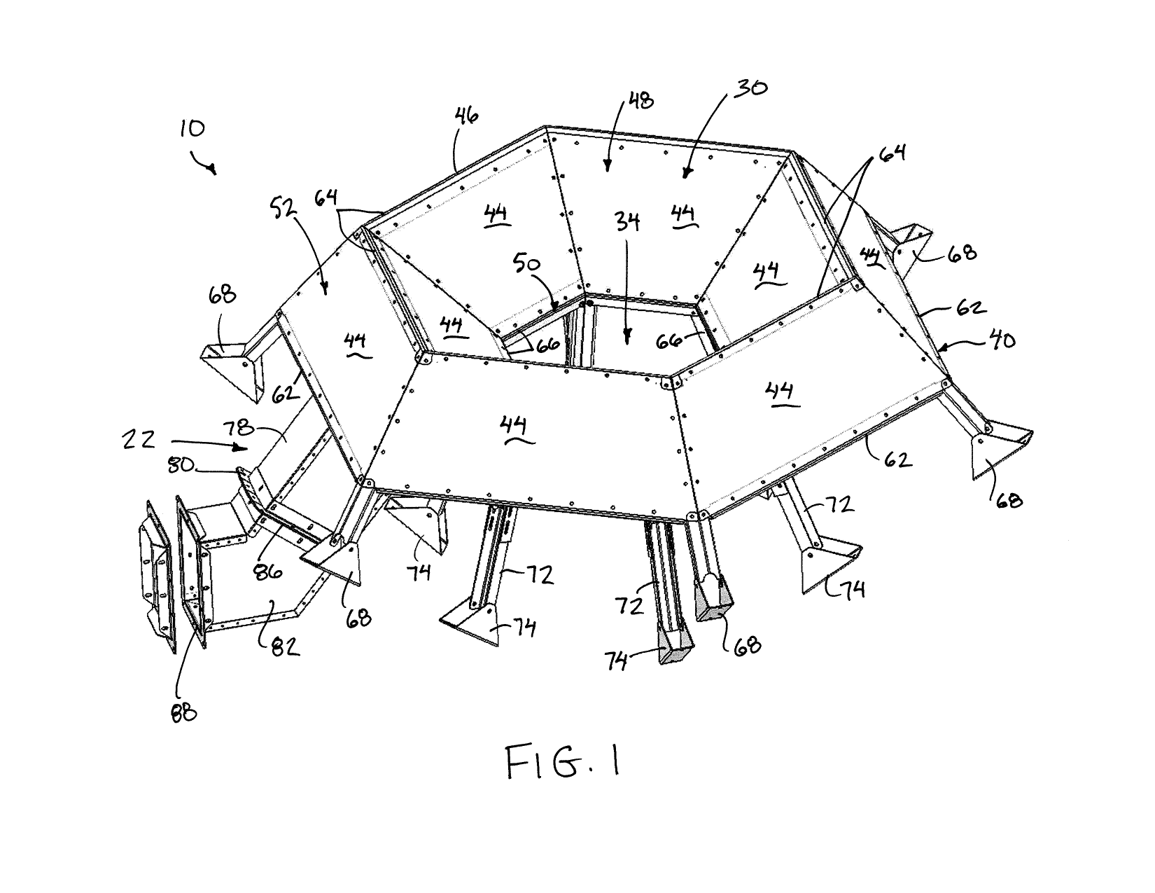

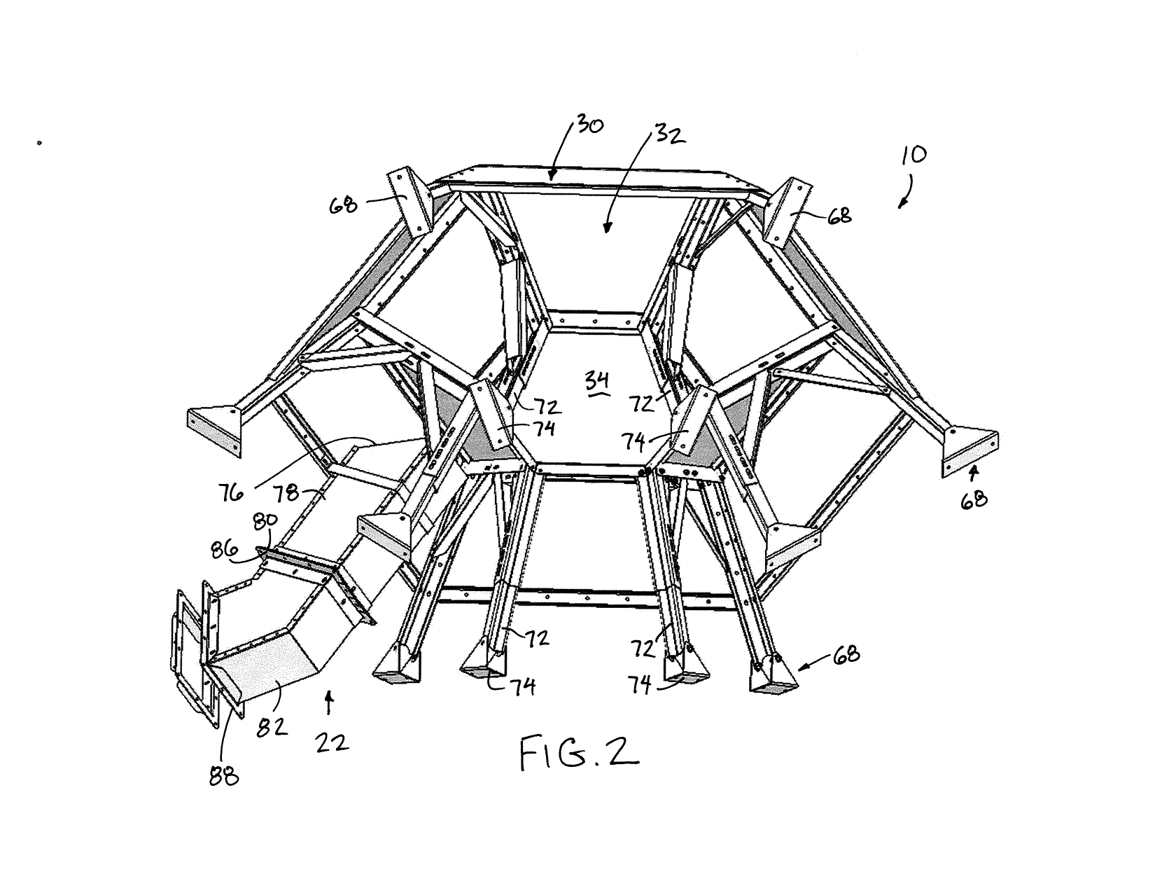

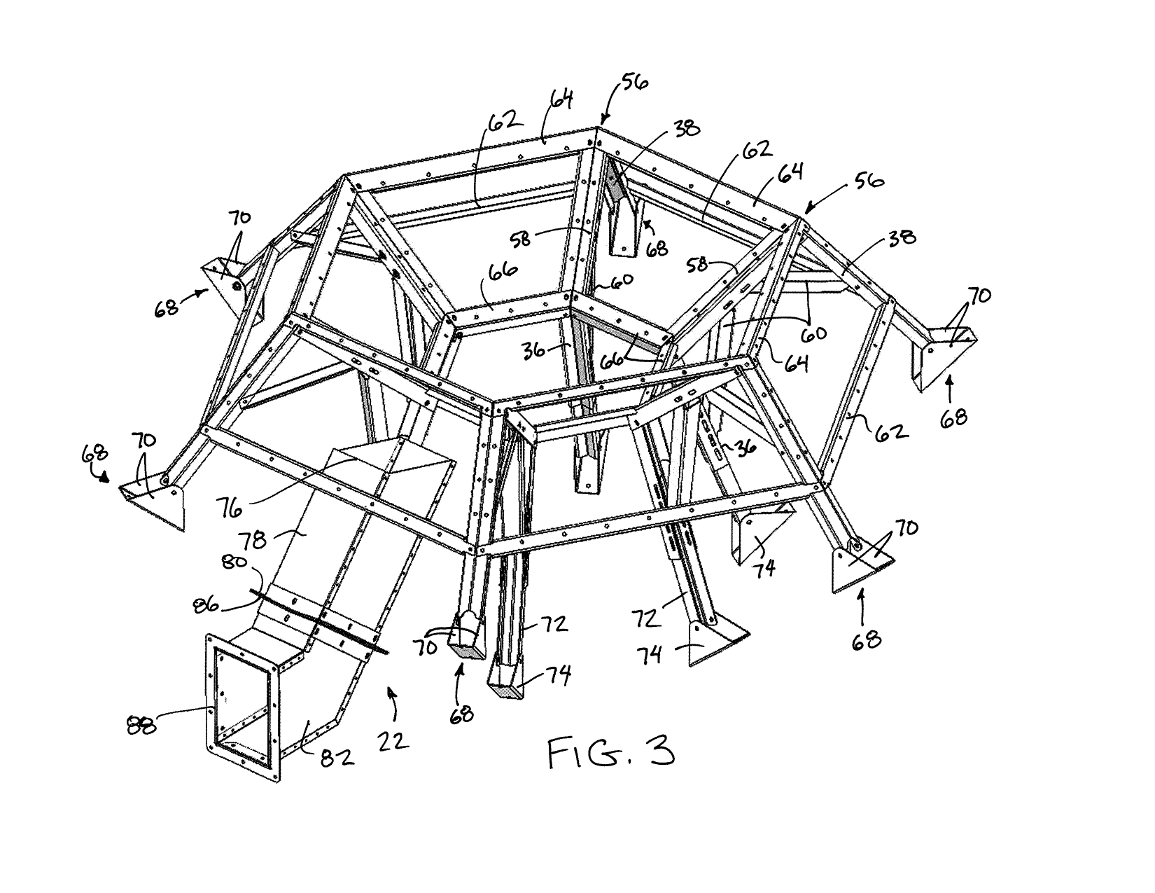

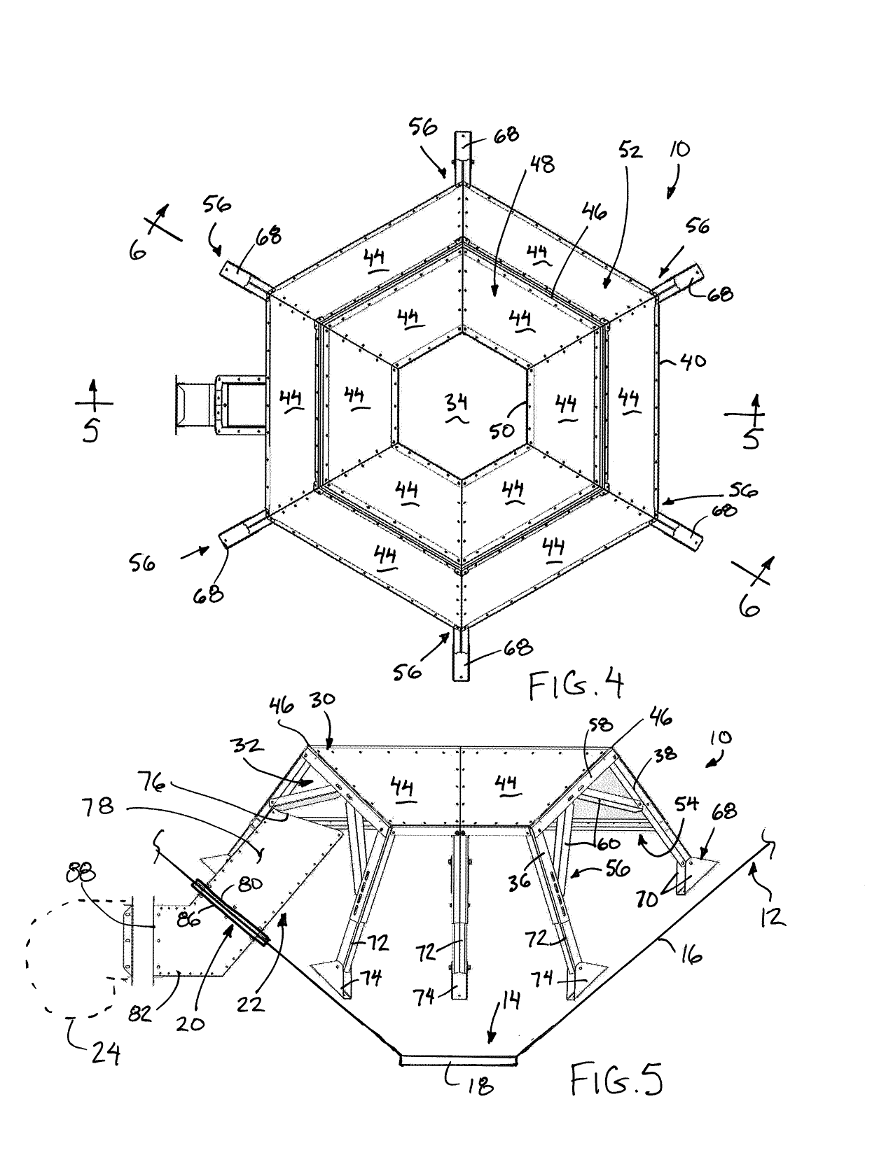

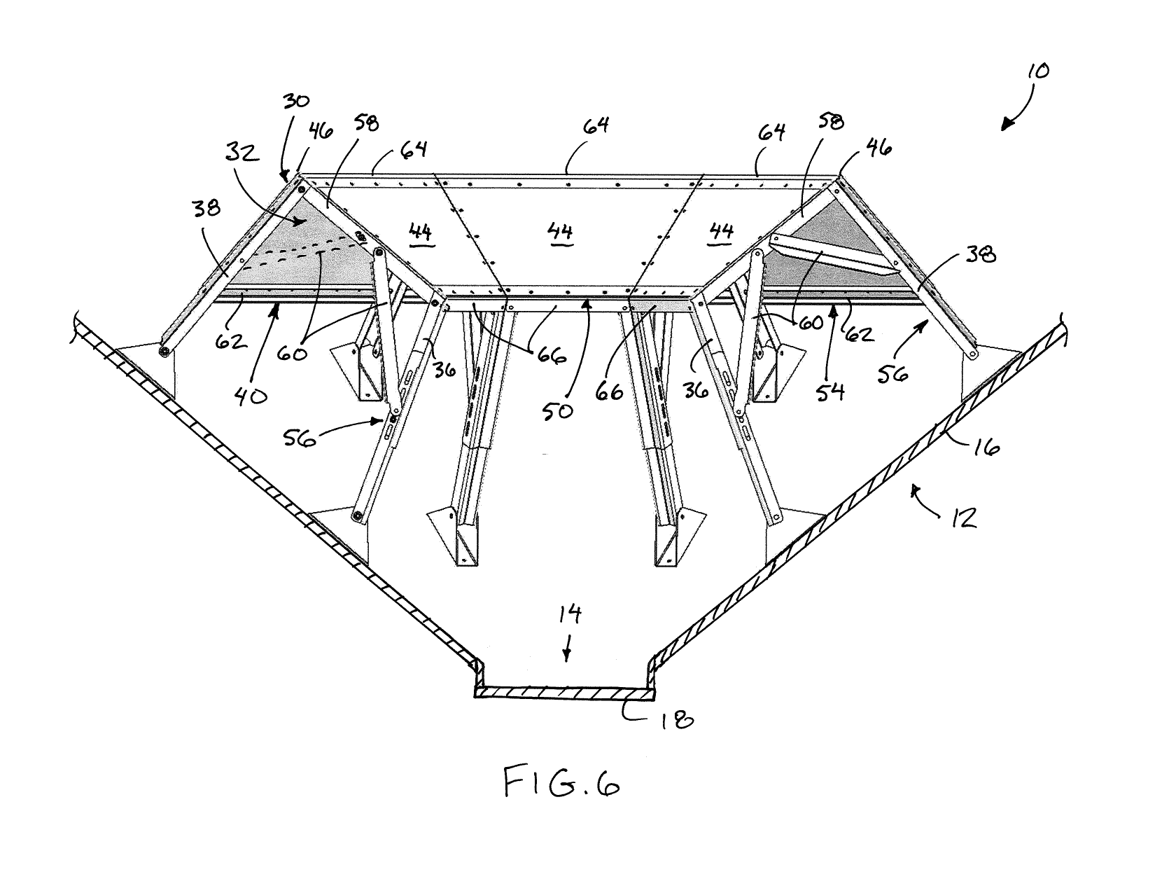

In the drawings like characters of reference indicate corresponding parts in the different figures.

### DETAILED DESCRIPTION

Referring to the accompanying figures, there is illustrated a grain bin aeration apparatus generally indicated by reference numeral 10. The apparatus 10 is particularly suited for use with a grain storage bin having a hopper bottom 12 for discharge of the stored grain within the bin through a central discharge opening 14 at a bottom of the bin.

The hopper bottom 12 of the storage bin comprises a bottom wall 16 tapering downwardly and radially inwardly at a slope in a range of 35 to 75 degrees from horizontal from an upper perimeter edge of the hopper bottom to the central discharge opening at the bottom of the hopper bottom. A gate 18 is mounted at the central discharge opening 14 so as to be operable relative to the opening between an open position allowing discharge of the contents of the bin through the opening and a closed position in which the opening is closed to prevent discharge of material through the opening.

The grain bin is typically supported on legs (not shown) such that the central discharge opening 14 is spaced above ground or a suitable foundation. The legs extend downwardly from the hopper bottom at circumferentially spaced apart positions about the upper perimeter edge of the hopper bottom so as to support a cylindrical side wall (not shown) of the grain bin extending upwardly from the upper perimeter edge. The hopper bottom wall 16, the cylindrical side wall, and a roof (not shown) collectively define a bin boundary of the storage volume of the grain bin within which grain is contained and stored.

A duct opening 20 extends through the bin boundary at an intermediate location along a height of the hopper bottom wall 16 between the upper perimeter edge and the central discharge opening 14 of the bin wall. The duct opening 20 receives a supply duct 22 extending through the duct opening for communication between a blower 24 supported externally of the bin and the apparatus 10 supported internally within the bin. The blower 24 provides a supply of aeration air directed through the supply duct 22 into the interior of the grain bin, for subsequent distribution within the grain bin by the aeration apparatus 10 according to the present invention.

The aeration apparatus 10 generally comprises (i) a duct member 30 defining and aeration duct 32 following a generally annular path about a central opening 34 of the duct member, and (ii) inner leg members 36 and outer leg members 38 connected to the duct member 30 adjacent the central opening 34 and an outer perimeter edge 40 of the duct member respectively. The leg members 36 and 38 serve to support the duct member within the storage bin at a location spaced above the bottom wall 16 of the hopper bottom such that the central opening 34 of the apparatus 10 is substantially aligned concentrically with the central discharge opening 14 and gate 18 of the hopper bottom, while the aeration duct 32 communicates with the supply duct 22 to receive a flow of aeration air from the supply duct into the aeration duct. The aeration duct 32 distributes the aeration air circumferentially about the annular path of the aeration duct for subsequent distribution into the surrounding grain stored within the grain bin.

The duct member 30 generally comprises (i) a modular frame assembly comprising a plurality of elongated frame members including the leg members 36 and 38 which are coupled to one another using threaded fasteners, and (ii) a plurality of panel sections 44 mounted onto the frame members also using threaded fasteners to define part of the boundary of the aeration duct 32. Each panel section 44 comprises a flat rigid sheet of perforated metal in which the perforated openings are sufficiently small to prevent passage of grain therethrough while allowing aeration air to be discharged through the perforations from the interior of the aeration duct 32 to the surrounding grain. Each panel section 44 is elongated in a circumferential direction of the duct member 30 such that the panel sections and the individual frame members can be readily inserted through a conventional man hole formed in a wall at the boundary of the storage bin or through the central discharge opening 14 when opened so that the components can be readily inserted into the interior the bin and then assembled once received within the interior of the bin.

As noted above, the assembled duct member 30 follows an annular path about a central opening 34. A cross-sectional shape of the aeration duct 32 is generally triangular including (i) an apex 46 at a top of the duct member at an intermediate location in the radial direction of the duct member, (ii) an inner wall 48 sloping downwardly and radially inwardly from the apex 46 to an inner perimeter edge 50 extending about the central opening 34, and (iii) an outer wall 52 sloping downwardly and radially outwardly from the apex 46 to the outer perimeter edge 40. The inner wall 48 and the outer wall 52 collectively define an upper boundary of the aeration duct 32 about the circumference of the aeration duct.

A bottom side 54 of the triangular shape of the duct member 30, corresponding to a lower boundary of the aeration duct 32, is fully open between the inner perimeter edge 50 and the outer perimeter edge 40. In further embodiments, the lower boundary may be partially restricted so as to be only partly open. According to the illustrated embodiment, the inner and outer perimeter edges are supported at substantially the same elevation such that a plane of the open bottom is generally horizontal. In further embodiments, the inner edge may extend below the outer edge; however a plane of the bottom preferably remains at least 70 degrees or greater from vertical corresponding to 20 degrees or less from horizontal so as to ensure that material flowing beneath the duct member along the sloped hopper bottom wall does not collect or become trapped on any frame members beneath the inner wall 48 adjacent to the inner perimeter edge for example.

Each of the apex 46, the inner perimeter edge 50 and the outer perimeter edge 40 have a generally polygonal shape while extending generally along the annular path of the duct member. According to the illustrated embodiment, the apex and the edges 40 and 50 follow a hexagonal path, however in further embodiments the polygonal shape may form a pentagon, a heptagon, an octagon, or other shapes dependent upon the number of sections of the duct member that are connected adjacent one another in the circumferential direction. Likewise, the inner wall 48 and the outer wall 52 are formed of the flat panel sections 44 so that the inner wall and the outer wall follow the polygonal shape of the perimeter edges 40 and 50. More particularly, each panel section 44 generally has the shape of an isosceles trapezoid in which the parallel edges are located at the apex and at the inner and outer edges respectively, while the nonparallel edges of the panel sections are mounted adjacent to corresponding edges of adjacent panel sections in the circumferential direction.

The inner wall 48 and the outer wall 52 are each mounted to extend at a downward and radial slope from the apex to the corresponding perimeter edge that is at least 40 degrees from horizontal. Accordingly an interior angle of the duct member at the apex is at most 100 degrees, and preferably is at least 60 degrees. This ensures that no grain becomes trapped on the upper surfaces of the duct member.

The triangular shape of the aeration duct 32 is arranged such that the longest side of the triangle is located at the open bottom resulting in the bottom side extending between the inner perimeter edge 50 and the outer perimeter edge 40 having a radial dimension which is greater than a height of the duct between the apex 46 and the open bottom side 54 of the aeration duct.

The duct member 30 is sized such that an inner diameter of the central opening 34 measured between opposing portions of the inner perimeter edge 50 is preferably at least 2 feet, up to a maximum of 6 feet. This ensures that the central opening does not interfere with a vertical flow of grain downwardly through the centre of the bin when opening the discharge gate of the hopper bottom for discharging grain from the bin. The duct member 30 is also sized such that an outer diameter defined at the outer perimeter edge 40 is preferably greater than 5 feet up to a maximum of 16 feet. In this manner, there is sufficient clearance between the outer perimeter edge of the duct member and the surrounding cylindrical wall of the grain bin to allow grain to readily flow down the side walls of the bin along the bottom wall 16 of the hopper bottom to the central discharge.

The frame assembly of the duct member is assembled from the elongate frame members for supporting the panel sections 44 thereon in the prescribed shape described above. More particularly, the frame assembly includes a plurality of subassemblies 56 that are generally radially oriented at each corner of the polygonal perimeter shape of the duct member. Each subassembly includes (i) one of the outer leg members 38 extending from the apex 46 towards the outer perimeter edge to protrude beyond the outer perimeter edge, at a junction between side edges of two adjacent panel sections 44 of the outer wall 52, (ii) a crossbar 60 extending from the apex 46 to the inner perimeter edge at a junction between side edges of two adjacent panel sections of the inner wall 50, (iii) one of the inner leg members 36 extending downwardly from the inner perimeter edge, and (iv) a pair of braces 60 extending from an intermediate location on the crossbar 58 to respective ones of the inner leg member 36 and the outer leg member 38 so as to support the inner leg member and the outer leg member in a generally U-shaped configuration together with the crossbar 58. The frame members of the subassembly 56 lie in a common vertical plane oriented radially of the annular path of the duct member.

The overall frame assembly also includes a plurality of outer perimeter members 62 which extend end to end with one another about the outer perimeter edge 40 so that each outer perimeter member 62 extends between an intermediate location on the outer leg member 38 of one subassembly to a corresponding intermediate location on the outer leg member of an adjacent subassembly. Each outer leg member 38 protrudes beyond the outer perimeter members 62 by a protruding distance which determines the height of the outer perimeter edge of the duct member from the bottom wall of the hopper bottom.

The overall frame assembly also includes a plurality of apex members 64 which extend end to end with one another about the apex so that each apex member extends between the junction of the crossbar 58 and the outer leg member 38 of one subassembly to the same junction of an adjacent subassembly.

The frame assembly further includes a plurality of inner perimeter members 66 which extend end to end with one another about the inner perimeter edge so that each inner perimeter member 66 extends between a junction of the crossbar 58 and the inner leg member 36 of one subassembly to the same junction of an adjacent subassembly.

An outer foot 68 is mounted at the bottom end of each outer leg member 62 using a pivotal connection such that the outer foot 68 is angularly adjustable about an axis that is perpendicular to a radial axis of the duct member while being parallel to the hopper wall. Each outer foot 68 includes a flat bottom plate for mounting flat against the hopper wall to prevent collection of material thereon and a pair of side plates 70 extending upwardly from laterally opposing side edges of the bottom plate to support the bottom end of the corresponding outer leg member 62 between the side plates using a pivot pin extending laterally through the outer leg member between the side plates. The side plates are parallel to a radial axis, again to prevent any grain from being trapped on the foot 68.

Each inner leg member 36 cooperates with an extension member 72 in which the extension member comprises another frame member having a cross-sectional shape closely matching the inner leg member so as to couple the extension member 72 with the leg member in a telescoping manner. More particularly, each inner leg member and the respective extension member are linearly inline with one another, but adjustable in overall length depending upon the amount of overlap in the longitudinal direction between the extension member 72 and the inner leg member 36. An inner foot 74 is mounted at the bottom end of the extension member 72 which is configured substantially identically to the outer foot 68. In this manner, each inner foot 74 and each outer foot 68 of each subassembly 56 is angularly adjustable so that the bottom side of the foot can be mounted flat against the inner surface of the hopper wall regardless of the slope of the hopper wall varying between 35 and 75 degrees from horizontal. The extension of the length of each inner leg member also serves to accommodate varying slopes of hopper walls as the inner perimeter edge will be supported at varying distances to the hopper wall according to different hopper wall slopes even when the outer perimeter edge is supported at the same distance to the hopper wall.

In the illustrated embodiment, the supply duct 22 is a rectangular cross-section communicating through a corresponding shaped opening in the hopper wall. The supply duct is configured such that an inner end 76 of the supply duct is fully open and is located within the boundaries of the aeration duct 32 so that the inner end 76 is located fully above a plane of the open bottom side 54 of the triangular shape of the ration duct 32 to prevent entry of grain into the supply duct. The supply duct may be formed in sections including an interior section 78 extending from the open inner end 76 to an inner flange 84 mounted against the interior surface of the hopper wall, and an exterior section 82 extending from an outer flange 86 for mounting against the exterior surface of the hopper wall to an outer end 88 of the supply duct. The outer end 88 of the supply duct may be further configured with a corresponding flange for mounting to the suitable flange of a blower or other supply duct between the blower and the outer end of the supply duct 22.

As described above, the elongate frame members and the panel sections 44 may be provided as a kit that a user can readily insert into a grain bin through a suitable manhole or the bottom discharge gate for subsequent assembly within the interior of the bin. The frame members and the panel sections are assembled using threaded fasteners for bolting together with conventional tools. The outer legs are typically first mounted against the inner surface of the upper wall by pivotally adjusting the outer feet 68 so that the bottoms of the feet lie flat against the hopper wall. A length of the extension members 72 relative to the inner leg members 36 can then be adjusted and fixed at a prescribed spacing when the inner feet 74 are similarly pivoted flat into engagement against the hopper wall. In the mounted position, the central opening of the duct member 30 is preferably concentrically aligned above the central discharge of the hopper bottom so that the duct member is generally level and horizontal in a mounted position within the grain bin.

In the mounted position, a height of the outer perimeter edge 50 from the hopper wall is preferably less than a radial width of the aeration duct 32 between the inner perimeter edge 50 and the outer perimeter edge 40. This ensures that the open bottom of the aeration duct is close enough to the hopper bottom wall and is sufficiently open that a sufficient amount of the aeration air distributed through the annular path of the aeration duct 32 penetrates stored grain below the duct member 30 while simultaneously discharging aeration air through the perforated inner wall and outer wall forming the upper boundary of the aeration duct 32 for distribution into the grain above the duct member.

The aeration apparatus 10 is typically used in conjunction with a vent opening in the roof of the grain bin.

In operation, activation of the blower connected to the supply duct 22 supplies aeration air through the supply duct and into the aeration duct 32 for distribution along the annular path of the duct member, followed by distribution of air into the grain below the duct member through the open bottom and into the grain above the duct member through the perforated panels forming the upper boundary of the duct member. The aeration air continues to be distributed throughout the surrounding stored grain to pass upwardly through the stored grain for discharge through the vent opening at the roof of the bin.

Since various modifications can be made in the invention as herein above described, and many apparently widely different embodiments of same made, it is intended that all matter contained in the accompanying specification shall be interpreted as illustrative only and not in a limiting sense.

1. An aeration apparatus for a grain storage bin having a bin boundary partly defined by a hopper bottom wall tapering downwardly and radially inwardly to a central discharge gate and an air supply duct communicating through the bin boundary for receiving aeration air from an external blower, the aeration apparatus comprising:
a duct member defining an upper boundary of an aeration duct extending along an annular path about a central opening and being at least partially open at a lower boundary of the aeration duct; and
a plurality of leg members arranged to support the duct member within the storage bin at a location spaced above the hopper bottom wall such that the central opening is generally aligned with the central discharge gate of the storage bin and such that the aeration duct communicates with the air supply duct to distribute the aeration air from the external blower within the storage bin.

2. The aeration apparatus according to claim 1 wherein the duct member is perforated along the upper boundary of the duct.

3. The aeration apparatus according to claim 1 wherein the duct member defines a cross-sectional profile of the aeration duct having a triangular shape.

4. The aeration apparatus according to claim 3 wherein the duct member comprises an inner wall sloping downwardly and radially inwardly from an apex of the upper boundary and an outer wall sloping downwardly and radially outwardly from the apex of the upper boundary such that the inner wall and the outer wall collectively define the triangular shape of the aeration duct.

5. The aeration apparatus according to claim 4 wherein the apex has an interior angle which is less than 100 degrees.

6. The aeration apparatus according to claim 4 wherein each of the inner wall and the outer wall is sloped downwardly and outwardly from the apex at an angle of at least 40 degrees from horizontal.

7. The aeration apparatus according to claim 1 wherein the duct member is assembled from panel sections mounted onto a supporting frame, each panel section comprising a flat sheet.

8. The aeration apparatus according to claim 7 wherein each panel section is elongated in a circumferential direction of the annular path.

9. The aeration apparatus according to claim 7 wherein each panel section is joined to the supporting frame with fasteners.

10. The aeration apparatus according to claim 7 wherein the supporting frame is formed of elongated frame members joined to one another and to the leg members with fasteners.

11. The aeration apparatus according to claim 1 wherein the duct member has an outer perimeter that is polygonal in shape.

12. The aeration apparatus according to claim 1 wherein the aeration duct defines a radial dimension between an inner perimeter edge of the duct member that extends about the central opening and an outer perimeter edge of the duct member, the radial dimension being greater than a height of the duct between the upper boundary and the lower boundary of the duct.

13. The aeration apparatus according to claim 1 wherein the aeration duct defines a radial dimension between an inner perimeter edge of the duct member that extends about the central opening and an outer perimeter edge of the duct member, the radial dimension being greater than a height of the outer perimeter edge from the hopper bottom wall.

14. The aeration apparatus according to claim 1 wherein the leg members are arranged to support the duct member such that a height of the outer perimeter edge from the hopper bottom wall is greater than 6 inches.

15. The aeration apparatus according to claim 1 wherein the leg members are arranged to support the duct member such that a height of the outer perimeter edge from the hopper bottom wall is less than 30 inches.

16. The aeration apparatus according to claim 1 wherein a diameter of the central opening is at least 2 feet.

17. The aeration apparatus according to claim 1 wherein an outer diameter of the duct member is greater than 5 feet.

18. The aeration apparatus according to claim 1 wherein the plurality of leg members include inner leg members adjacent the central opening and outer leg members adjacent an outer perimeter of the duct member.

19. The aeration apparatus according to claim 18 wherein at least some of the leg members are adjustable in configuration relative to one another such that the leg members are mountable onto the hopper bottom wall having slope angle in a range of 35 to 75 degrees from horizontal.

20. The aeration apparatus according to claim 1 wherein the duct member is arranged to communicate with the air supply duct through the at least partially open lower boundary.
